(19) United States
(12) Patent Application Publication
(10) Pub. No.: US 2016/0133893 A1
(43) Pub. Date: May 12, 2016

(54) ELECTRONIC DEVICE BATTERY HOLDER

(71) Applicant: LIFESCAN SCOTLAND LIMITED, Inverness Inverness-shire (GB)

(72) Inventor: Kevin Kok Pek CHONG, Inverness (GB)

(21) Appl. No.: 14/902,907

(22) PCT Filed: Jul. 4, 2014
(86) PCT No.: PCT/EP2014/064373

§ 371 Date: Jan. 5, 2016

(30) Foreign Application Priority Data
Jul. 5, 2013 (GB) 1312148.8

(51) Int. Cl. H01M 2/10

(52) U.S. Cl. CPC H01M 2/1044; H01M 2220/30

(57) ABSTRACT

An electronic device battery holder (“EDBH”) for holding a battery with a positive pole and a negative pole includes at least one deflectable electrically-conductive positive terminal prong with a proximal end configured for fixed electrical connection to a power circuit of an electronic device, a deflectable distal end configured to contact a positive pole of a battery operably inserted into the EDBH, and a deflectable middle portion connecting the proximal end and the distal end. The EDBH also includes at least one compressible electrically-conductive negative terminal prong configured to exert a force on the operably inserted battery, to contact a negative pole of the battery, and for fixed electrical connection to the power circuit of the electronic device. The at least one deflectable electrically-conductive positive terminal prong is configured to deflect during insertion of a battery therein and to exert a compressive securing force on an operably inserted battery.

### FIELD OF THE INVENTION

The present invention relates, in general, to electronic device components and, in particular, to battery holders for electronic devices and related methods.

### BACKGROUND OF THE INVENTION

The determination (e.g., detection and/or concentration measurement) of an analyte in, or a characteristic of, a fluid sample is of particular interest in the medical field. For example, it can be desirable to determine glucose, ketone bodies, cholesterol, lipoproteins, triglycerides, acetaminophen, hematocrit and/or HbA1c concentrations in a sample of a bodily fluid such as urine, blood, plasma or interstitial fluid. Such determinations can be achieved using a hand-held test meter and associated analytical test strips that employ, for example, visual, photometric or electrochemical determination techniques. Such hand-held test meters, as well as a variety of other electronic devices, are typically configured to hold replaceable batteries (e.g., coin cell batteries) that are employed as the device's power supply.

### SUMMARY OF THE INVENTION

In a first aspect of the invention there is disclosed an electronic device battery holder for holding a battery with a positive pole and a negative pole, the electronic device battery holder comprising: at least one deflectable electrically-conductive positive terminal prong with: a proximal end configured for fixed electrical connection to a power circuit of an electronic device, a deflectable distal end configured to contact a positive pole of a battery operably inserted into the electronic device battery holder; and a deflectable middle portion connecting the proximal end and the distal end; at least one compressible electrically-conductive negative terminal prong configured to exert a force on the battery operably inserted into the electronic device battery holder, to contact a negative pole of the battery, to securely support and hold the battery in the electronic device battery holder, and for fixed electrical connection to the power circuit of the electronic device, and wherein the at least one deflectable electrically-conductive positive terminal prong is configured to deflect during insertion of a battery therein and exert a compressive securing force on an operably inserted battery while connecting a positive pole of the battery.

The deflectable distal end may include: a hook portion configured to provide the contact to the positive pole; and a release surface configured for a user to press, thereby defecting the deflectable distal end and releasing the battery.

The force exerted by the compressible electrically-conductive negative terminal prong may hold the battery against the hook.

The at least one compressible electrically-conductive negative terminal prong may have a proximal end, and the proximal end of the at least one deflectable electrically-conductive positive terminal prong and the proximal end of the at least one compressible electrically-conductive negative terminal prong may be configured for electrical connection to a printed circuit board (PCB).

The PCB may be a PCB of a hand-held test meter for the determination of an analyte in a bodily fluid sample.

The battery may be a coin cell battery.

The at least one deflectable electrically-conductive positive terminal prong may be a plurality of deflectable electrically-conductive positive terminal prongs.

Each of the plurality of deflectable electrically-conductive positive terminal prongs may have a proximal end configured for fixed electrical connection to a power circuit of an electronic device and the proximal ends may be configured as an integrated ring-shaped base.

The at least one compressible electrically-conductive negative terminal prong may be a plate of predetermined configuration.

The electronic device may be a hand-held test meter configured for the determination of an analyte in a bodily fluid sample.

The analyte may be glucose and the bodily fluid sample may be whole blood.

The battery may be generally cylindrical in shape.

The at least one compressible electrically-conductive negative terminal prong may be configured to be disposed within a circumference defined by at least one deflectable electrically-conductive positive terminal prong when the electronic device battery holder is attached to an electronic device.

The at least one compressible electrically-conductive negative terminal prong may be a plurality of electrically-conductive negative terminal prongs and wherein each of the plurality of compressible electrically-conductive negative terminal prongs may have a proximal end configured for fixed electrical connection to a power circuit of an electronic device and the proximal ends may be configured as an integrated ring-shaped base.

In a second aspect of the invention, there is provided a method for using an electronic device battery holder comprising: operably inserting a battery into an electronic-device battery holder such that: at least one deflectable electrically-conductive positive terminal prong of the electronic device battery holder deflects during the insertion, exerts a compressive securing force on the operably inserted battery and contacts a positive pole of the inserted battery; and at least one compressible electrically-conductive negative terminal prong is compressed, exerts a securing force on the operably inserted battery, and contacts a negative pole of the battery, and releasing the operably inserted battery by depressing a release surface of the at least one deflectable electrically-conductive positive terminal prong, thereby removing the compressive securing force and such that the force of the compressible electrically-conductive negative terminal prong pushes the battery from operable insertion in the electronic device battery holder.

The at least one deflectable electrically-conductive positive terminal prong may have a deflectable distal end that includes: a hook portion configured to provide the contact to the positive pole; and the release surface.

The force exerted by the at least one compressible electrically-conductive negative terminal prong may hold the battery against the hook.

The at least one compressible electrically-conductive negative terminal prong may have a proximal end and the at least one deflectable electrically-conductive positive terminal prong has a proximal end, and wherein the proximal end of the at least one deflectable electrically-conductive positive terminal prong and the proximal end of the at least one compressible electrically-conductive negative terminal prong are configured for electrical connection to a printed circuit board (PCB).

The PCB may be a PCB of a hand-held test meter for the determination of an analyte in a bodily fluid sample.

The battery may be a coin cell battery.

The at least one deflectable electrically-conductive positive terminal prong may be a plurality of deflectable electrically-conductive positive terminal prongs.

The at least one compressible electrically-conductive negative terminal prong may be a plate of predetermined configuration.

The electronic device may be a hand-held test meter configured for the determination of an analyte in a bodily fluid sample.

The analyte may be glucose and the bodily fluid sample may be whole blood.

The battery may be generally cylindrical in shape.

The at least one compressible electrically-conductive negative terminal prong may be configured to be disposed within a circumference defined by at least one deflectable electrically-conductive positive terminal prong when the electronic device battery holder is attached to an electronic device.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention, in which:

FIG. 1 is a simplified perspective view of an electronic device battery holder according to an embodiment of the present invention;

FIG. 2 is a simplified side view of the electronic device battery holder of FIG. 1;

FIG. 3A is simplified top view of the electronic device battery holder of FIG. 1;

FIG. 3B is a simplified top view of the electronic device battery holder of FIG. 1 with that includes three cross-sectional lines, i.e., line D-D, line E-E and line F-F;

FIG. 4 is a simplified cross-sectional view of the electronic device battery holder of FIG. 1 taken along a combination of lines D-D, E-E and F-F of FIG. 3B;

FIG. 5 is a simplified perspective view of a Printed Circuit Board (PCB) that can be employed with embodiments of the present invention;

FIG. 6 is a simplified perspective view of the electronic device battery holder of FIG. 1 operatively attached to the PCB of FIG. 5;

FIG. 7 is simplified cross-sectional side view of the electronic device battery holder of FIG, 1 operatively attached to the PCB of FIG. 5 as a coin cell battery (CCB) is being inserted therein with dashed lines depicting the deflection of a deflectable electrically-conductive positive terminal prong during such an insertion, a straight arrow (labeled G) indicating the direction of insertion and curved arrows (both labeled H) indicating the direction of deflection;

FIG. 8 is a simplified cross-sectional side view of the electronic device battery holder of FIG, 1 operatively attached to the PCB of FIG. 5 and with a coin cell battery operably inserted therein, with arrows (labeled I) depicting a compressive force securing the CCB and arrows (labeled J) depicting a force exerted by at least one compressible electrically-conductive negative terminal prong of the electronic device battery holder;

FIG. 9 is a simplified cross-sectional side view depicting a coin cell battery in the process of being released from the electronic device battery holder of FIG. 8 with arrow K indicating pressure applied by a user to the release surface of the deflectable electrically-conductive positive terminal prong, with arrow L indicating a resulting deflection, arrows M indicating a force applied by the at least one compressible electrically-conductive negative terminal prong and arrow N indicating the direction of CCB release; and

FIG. 10 is a flow diagram depicting stages in a method for inserting and removing a battery from a battery holder according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. The term “prong” refers to a projecting part and the term “plate” to a flat, thin piece of material.

In general, electronic device battery holders for holding a battery with a positive pole and a negative pole (such as a coin cell battery) according to embodiments of the present invention include at least one deflectable electrically-conductive positive terminal prong with a proximal end configured for fixed electrical connection to a power circuit of an electronic device, a deflectable distal end configured to contact a positive pole of a battery operably inserted into the electronic device battery holder, and a deflectable middle portion connecting the proximal and distal ends. The electronic device battery holder also includes at least one compressible electrically-conductive negative terminal prong configured to exert a force on a battery operably inserted into the electronic device battery holder, to contact a negative pole of the battery, to securely support and hold the battery in the electronic device battery holder, and for fixed electrical connection to the power circuit of the electronic device. In addition, the at least one deflectable electrically-conductive positive terminal prong is configured to deflect during insertion of a battery therein and exert a compressive securing force on an operably inserted battery.

Electronic device battery holders according to embodiments of the present invention are beneficial in that, for example, they include a minimal number of components (thereby simplifying handling and assembly) and do not require the inclusion or use of a dedicated battery housing, plastic cover and/or battery removal ribbon. The inclusion of a minimal number of parts results in a beneficially inexpensive electronic device battery holder that can be easily incorporated into a variety of electronic devices including, for example, hand-held test meters for the determination of an analyte (e.g., glucose) in a bodily fluid sample (such as a whole blood sample) using analytical test strips. Moreover, once apprised of the present disclosure, one skilled in the art will recognize that electronic device battery holders according to embodiments of the present invention can be readily sized and/or configured to operatively hold a variety of battery types including coin cell batteries (e.g., lithium coin cell batteries), AA batteries, AAA size batteries or other suitable batteries that are generally cylindrical in shape. Embodiments of the present invention are also beneficial in that they efficiently use compression and defection forces generated by the deflectable electrically-conductive positive terminal prong(s) and the compressible electrically-conductive negative terminal prong(s) to accomplish three tasks, namely to securely hold a battery, to provide an electrical connection between an electronic device and a battery, and to release a battery.

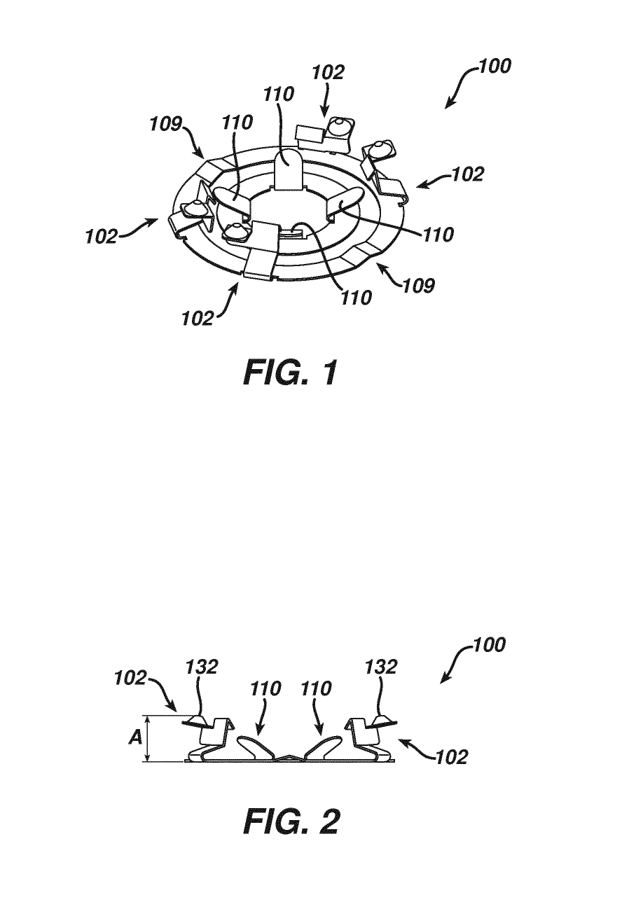

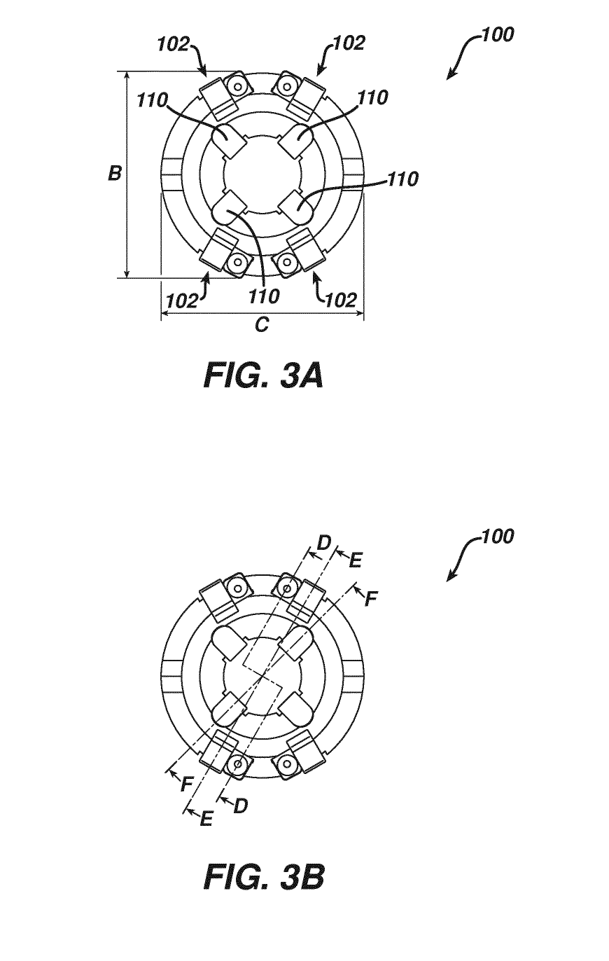

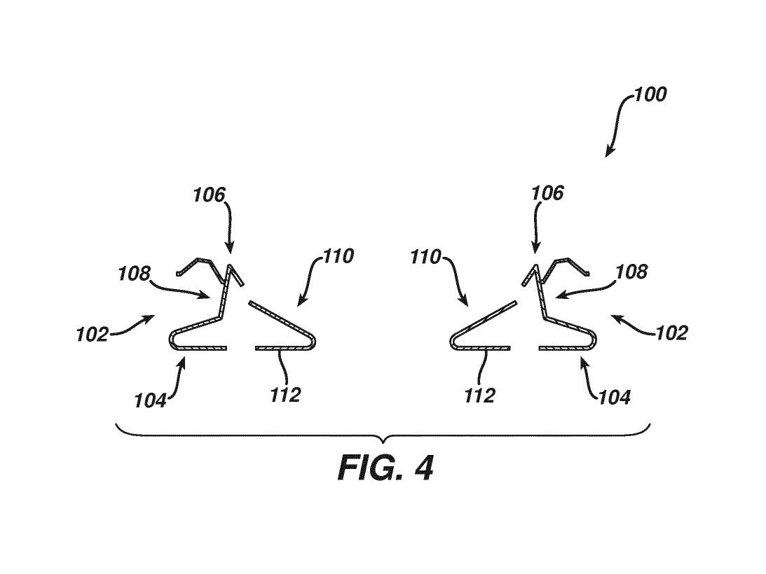

FIG. 1 is a simplified perspective view of an electronic device battery holder 100 according to an embodiment of the present invention. FIG. 2 is a simplified side view of the electronic device battery holder 100. FIGS. 3A and 3B are simplified top views of the electronic device battery holder 100. FIG. 3B depicts three cross-sectional lines (i.e., lines D-D, E-E and F-F). FIG. 4 is a simplified cross-sectional view of the electronic device battery holder 100 that.

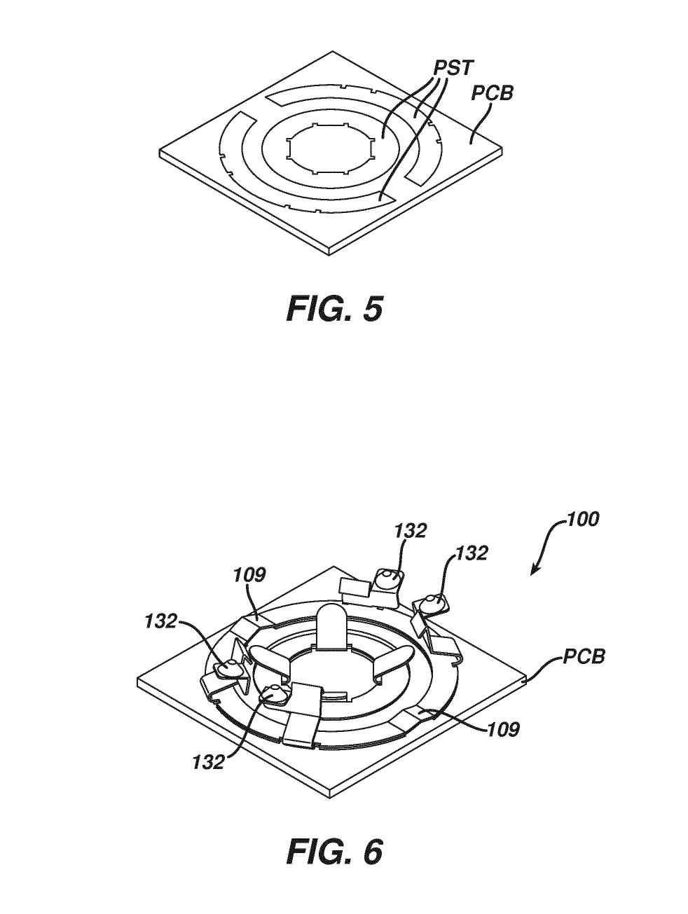

FIG. 5 is a simplified perspective view of a Printed Circuit Board (PCB) as can be employed with electronic device battery holder 100. FIG. 6 is a simplified perspective view of electronic device battery holder 100 attached to the PCB of FIG. 5. The PCB of FIG. 5 includes solder paste (PST) for the operable mounting of electronic device battery holder 100 to the PCB.

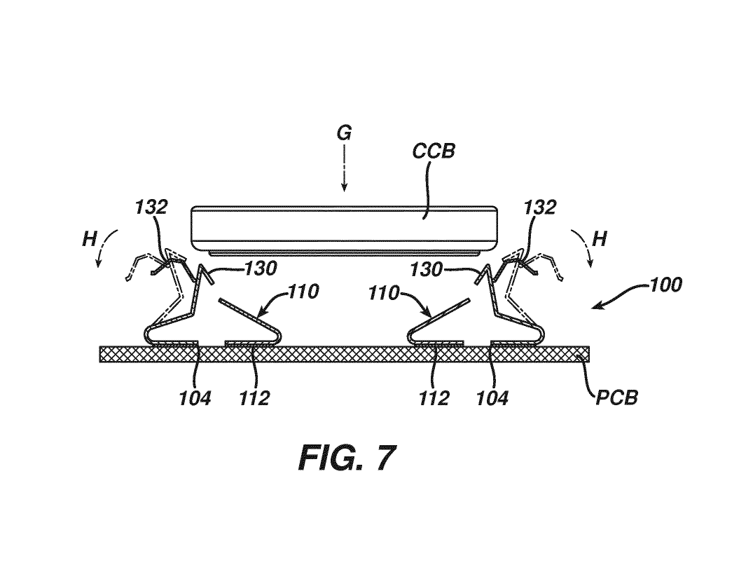

FIG. 7 is simplified cross-sectional side view of electronic device battery holder 100 operatively attached to a printed circuit board (PCB) as a coin cell battery (CCB) is being inserted therein with dashed lines depicting the deflection of deflectable electrically-conductive positive terminal prongs during such an insertion, a straight arrow (labeled G) indicating the direction of insertion and curved arrows (both labeled H) indicating the direction of deflection.

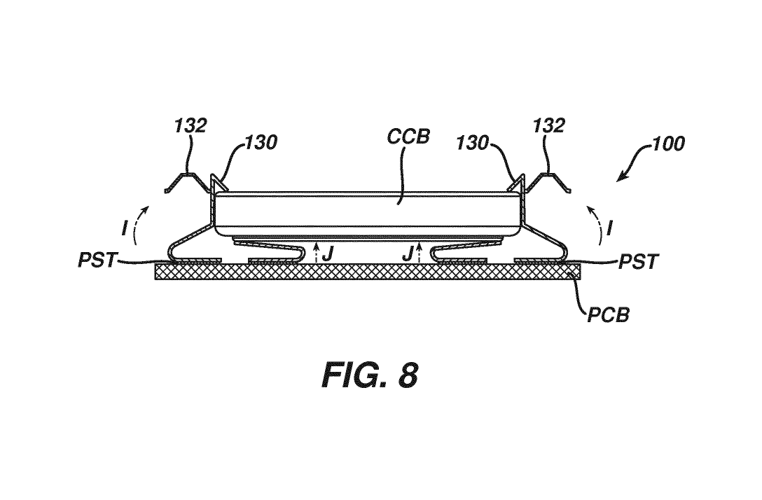

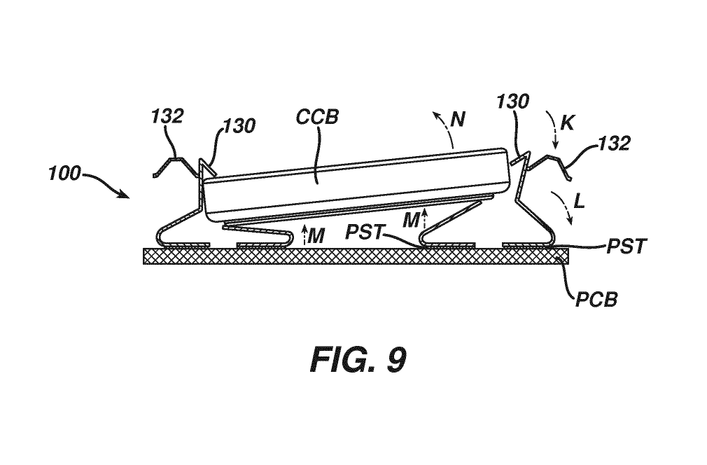

FIG. 8 is a simplified cross-sectional side view of electronic device battery holder 100 of FIG. 1 operatively attached to the printed circuit board (PCB) of FIG. 5 and with a coin cell battery operably inserted therein with arrows (labeled I) depicting a compressive force securing the CCB and arrows (labeled J) depicting a force exerted by at least one compressible electrically-conductive negative terminal prong of electronic device battery holder 100. FIG. 9 is a simplified cross-sectional side view depicting a coin cell battery in the process of being released from electronic device battery holder 100 of FIG. 8 with arrow K indicating pressure applied by a user to the release surface of the deflectable electrically-conductive positive terminal prong of electronic device battery holder 100, arrow L indicating a resulting deflection, arrows M indicating a force applied by the compressible electrically-conductive negative terminal prongs and arrow N indicating the direction of CCB release.

It should be noted that for explanatory purposes and simplicity the cross-sectional depictions of FIGS. 4, 7, 8 and 9 are each an aligned combination of cross-sectional views taken along lines D-D, E-E and F-F of FIG. 3B.

Referring to FIGS. 1-9, electronic device battery holder 100 is configured for holding a battery with positive and negative poles and includes a plurality of deflectable electrically-conductive positive terminal prongs 102 (namely four deflectable electrically-conductive positive terminal prongs, each labeled 102). Each of the deflectable electrically-conductive positive terminal prongs 102 includes a proximal end 104 configured for fixed electrical connection to a power circuit (not shown) of an electronic device via the PCB, a deflectable distal end 106 configured to contact a positive pole of the CCB inserted into the electronic device battery holder; and a deflectable middle portion 108 connecting the proximal end and the distal end. Since electronic device battery holder 100 has four deflectable electrically-conductive positive terminal prongs, there are also four proximal ends 104, four deflectable distal ends 106 and four deflectable middle portions 108.

In the embodiment of FIGS. 1-4 and 6-9, the four proximal ends 104 are integrated into a single ring-shaped base. This ring-shaped base includes two chevrons 109 configured to provide for the passage of electrical wiring (not depicted in the FIGs.) on the surface of the PCB to pass underneath of the single ring-shaped base. The height (labeled “A” in FIG. 2) of the deflectable electrically-conductive positive terminal prongs can be any suitable height including, for example, a height of 5.55 mm. The total depth (labeled “B” in FIG. 3A) of the deflectable electrically-conductive positive terminal prongs 102 can be any suitable depth including, for example, a depth of 26.62 mm. The width (labeled “C” in FIG. 3A) of the deflectable electrically-conductive positive terminal prongs 102 can be any suitable width including, for example, a width of 25.04 mm.

Electronic device battery holder 100 also includes a plurality (i.e., four) compressible electrically-conductive negative terminal prongs 110 that are configured to exert a force on the CCB operably inserted into the electronic device battery holder 100 (as represented by the arrows label J in FIG. 8 and M in FIG. 9), to contact a negative pole of the CCB, to securely support and hold the battery in the electronic device battery holder, and for fixed electrical connection to the power circuit of the electronic device (not shown) via the PCB. In addition, each of the compressible electrically-conductive negative terminal prongs 110 has a proximal end 112 configured for electrical connection to a printed circuit board (PCB). In the embodiment of FIGS. 1-4 and 6-9, the four proximal ends 112 are integrated into a single ring-shaped base. Compressible electrically-conductive negative terminal prongs 110 can be configured to provide any suitable compressive force including, for example, a compressive force in the range of 100 grams-force to 200 grams-force.

In electronic device battery holders according to embodiments of the present invention including electronic device battery holder 100, the plurality of compressible electrically-conductive negative terminal prongs are configured to be disposed essentially within a boundary (e.g., a circumference) defined by at least one deflectable electrically-conductive positive terminal prong when the electronic device battery holder is attached to an electronic device. Such a configuration is most clearly evident from the top views depicted in FIGS. 6 and 8 wherein the four proximal deflectable electrically-conductive positive terminal prongs 102 form a circumference (ring) and the four compressible electrically-conductive negative terminal prongs 110 are disposed within that circumference. Since the plurality of compressible electrically-conductive negative terminal prongs are within such a circumference and also under an inserted battery (see, for example, FIG. 8), any risk of a user inadvertently creating a deleterious short circuit between the compressible electrically-conductive negative terminal prongs and the deflectable electrically-conductive positive terminal prongs during battery insertion is minimized.

In electronic device battery holder 100, deflectable electrically-conductive positive terminal prongs 102 are configured to deflect during insertion of a battery therein and exert a compressive securing force (represented by the arrows labeled I in FIG. 8) on an operably inserted CCB. This deflection is represented by the dashed lines and arrows of FIG. 7 and is enabled by the flexible properties of the material of which the deflectable electrically-conductive terminal prongs are formed. Deflectable electrically-conductive positive terminal prongs 102 can be configured to provide any suitable compressive force including, for example, a compressive force in the range of 50 grams-force to 100 grams-force.

In the embodiment of FIGS. 1-4 and 6-9, deflectable distal ends 106 each includes a hook portion 130 configured to provide an electrical contact to the positive pole of the CCB and a release surface 132 configured for a user to press (denoted by arrow K in FIG. 9), thereby defecting a deflectable distal end (depicted by arrow L of FIG. 9) and releasing the CCB (depicted by the arrow labeled N in FIG. 9). It should be noted that the force exerted by the compressible electrically-conductive negative terminal prongs 110 holds the CCB against hook portions 130 as depicted in FIG. 8 during use. Such a force can be of any suitable magnitude including a force in, for example, the range of 100 grams to 200 grams of force. Release surfaces 132 are embossed with a conical shape (see FIG. 2 in particular) to enable a user to easily use a single finger pressing motion to release a battery from electronic device battery holder 100.

Electronic device battery holders according to embodiments of the present invention can be manufactured using any suitable techniques including, for example, metal stamping and forming techniques. Deflectable electrically-conductive positive terminal prongs and compressible electrically-conductive negative terminal prongs can, for example, be made formed of predetermined configuration from a thin metal plate. Moreover, the compressible electrically-conductive negative terminal prong(s) is configured to be disposed within a circumference defined by at least one deflectable electrically-conductive positive terminal prong when the electronic device battery holder is attached to an electronic device (see, for example, FIG. 3).

Deflectable electrically-conductive positive terminal prongs and compressible electrically-conductive negative terminal prongs employed in embodiments of the present invention can be formed from any suitable materials including, for example, carbon steel, beryllium copper, stainless steel, phosphor bronze materials. In addition, the thickness of such materials can be, for example, in the range of 0.2 mm to 0.5 mm.

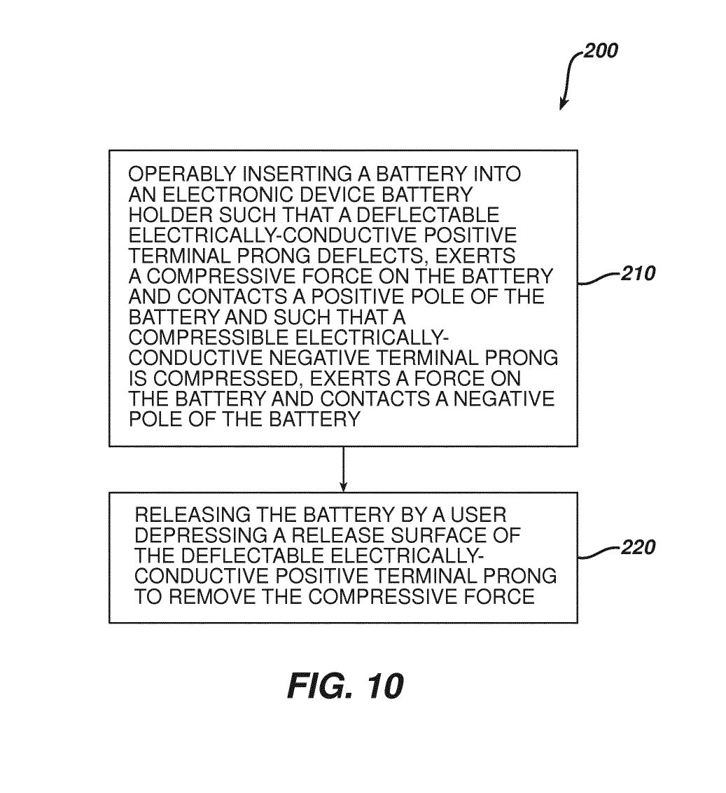

FIG. 10 is a flow diagram depicting stages in a method 200 for using an electronic device battery holder. Referring to FIG. 10 as well as FIG. 7 and FIG. 9, method 200 includes, at step 210 of FIG. 10, operably inserting a battery (such as a coin cell battery) into an electronic-device battery holder. The operable insertion is such that (i) at least one deflectable electrically-conductive positive terminal prong of the electronic device battery holder deflects during the insertion, exerts a compressive securing force on the operably inserted battery and contacts a positive pole of the inserted battery; and (ii) at least one compressible electrically-conductive negative terminal prong is compressed, exerts a force on the operably inserted battery (e.g., a securing force that holds the battery in the electronic device battery holder), and contacts a negative pole of the battery. See also, FIGS. 7 and 8 and their descriptions herein.

At step 220 of method 200, the operably inserted battery is released by a user depressing a release surface of the at least one deflectable electrically-conductive positive terminal prong, thereby removing the compressive securing force. The removal of the securing compressive force is such that the force of the compressible electrically-conductive negative terminal prong pushes the battery from operable insertion in the electronic device battery holder. See also, FIG. 9 and its description above.

Method 200 is beneficial in that, for example, the battery can be operably inserted by a user with a simple downward pressing motion (see arrow G of FIG. 7) and the battery is released (in the direction of arrow N in FIG. 9) using a simple downward pressing motion (in the direction of arrow K in FIG. 9) without the cumbersome use of a battery removal ribbon.

Once apprised of the present disclosure, one skilled in the art will recognize that method 200 can be readily modified to incorporate any of the techniques, benefits, features and characteristics of electronic device battery holders according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

1-26. (canceled)

27. An electronic device battery holder for holding a battery with a positive pole and a negative pole, the electronic device battery holder comprising:
at least one deflectable electrically-conductive positive terminal prong with:
a proximal end configured for fixed electrical connection to a power circuit of an electronic device,
a deflectable distal end configured to contact a positive pole of a battery operably inserted into the electronic device battery holder; and
a deflectable middle portion connecting the proximal end and the distal end;
at least one compressible electrically-conductive negative terminal prong configured to exert a force on the battery operably inserted into the electronic device battery holder, to contact a negative pole of the battery, to securely support and hold the battery in the electronic device battery holder, and for fixed electrical connection to the power circuit of the electronic device, and
wherein the at least one deflectable electrically-conductive positive terminal prong is configured to deflect during insertion of a battery therein and exert a compressive securing force on an operably inserted battery while connecting a positive pole of the battery.

28. The electronic device battery holder of claim 27 wherein the deflectable distal end includes:
a hook portion configured to provide the contact to the positive pole; and
a release surface configured for a user to press, thereby defecting the deflectable distal end and releasing the battery.

29. The electronic device battery holder of claim 28 wherein the force exerted by the compressible electrically-conductive negative terminal prong holds the battery against the hook.

30. The electronic device battery holder of claim 27 wherein the at least one compressible electrically-conductive negative terminal prong has a proximal end, and
wherein the proximal end of the at least one deflectable electrically-conductive positive terminal prong and the proximal end of the at least one compressible electrically-conductive negative terminal prong are configured for electrical connection to a printed circuit board (PCB).

31. The electronic device battery holder of claim 30 wherein the PCB is a PCB of a hand-held test meter for the determination of an analyte in a bodily fluid sample.

32. The electronic device battery holder of claim 27 wherein the battery is a coin cell battery.

33. The electronic device battery holder of claim 27 wherein the at least one deflectable electrically-conductive positive terminal prong is a plurality of deflectable electrically-conductive positive terminal prongs.

34. The electronic device battery holder of claim 33 wherein each of the plurality of deflectable electrically-conductive positive terminal prongs has a proximal end configured for fixed electrical connection to a power circuit of an electronic device and the proximal ends are configured as an integrated ring-shaped base.

35. The electronic device battery holder of claim 27 wherein the at least one compressible electrically-conductive negative terminal prong is a plate of predetermined configuration.

36. The electronic device battery holder of claim 27 wherein the electronic device is a hand-held test meter configured for the determination of an analyte in a bodily fluid sample.

37. The electronic device battery holder of claim 36 wherein the analyte is glucose and the bodily fluid sample is whole blood.

38. The electronic device battery holder of claim 27 wherein the battery is generally cylindrical in shape.

39. The electronic device battery holder of 27, wherein the at least one compressible electrically-conductive negative terminal prong is configured to be disposed within a circumference defined by at least one deflectable electrically-conductive positive terminal prong when the electronic device battery holder is attached to an electronic device.

40. The electronic device battery holder of claim 27 wherein the at least one compressible electrically-conductive negative terminal prong is a plurality of electrically-conductive negative terminal prongs and wherein each of the plurality of compressible electrically-conductive negative terminal prongs has a proximal end configured for fixed electrical connection to a power circuit of an electronic device and the proximal ends are configured as an integrated ring-shaped base.

41. A method for method for using an electronic device battery holder comprising:
operably inserting a battery into an electronic-device battery holder such that:
at least one deflectable electrically-conductive positive terminal prong of the electronic device battery holder deflects during the insertion, exerts a compressive securing force on the operably inserted battery and contacts a positive pole of the inserted battery; and
at least one compressible electrically-conductive negative terminal prong is compressed, exerts a securing force on the operably inserted battery, and contacts a negative pole of the battery, and
releasing the operably inserted battery by depressing a release surface of the at least one deflectable electrically-conductive positive terminal prong, thereby removing the compressive securing force and such that the force of the compressible electrically-conductive negative terminal prong pushes the battery from operable insertion in the electronic device battery holder.

42. The method of claim 41 wherein the at least one deflectable electrically-conductive positive terminal prong has a deflectable distal end that includes:
a hook portion configured to provide the contact to the positive pole; and
the release surface.

43. The method of claim 42 wherein the force exerted by the at least one compressible electrically-conductive negative terminal prong holds the battery against the hook.

44. The method of claim 41 wherein the at least one compressible electrically-conductive negative terminal prong has a proximal end and the at least one deflectable electrically-conductive positive terminal prong has a proximal end, and
wherein the proximal end of the at least one deflectable electrically-conductive positive terminal prong and the proximal end of the at least one compressible electrically-conductive negative terminal prong are configured for electrical connection to a printed circuit board (PCB).

45. The method of claim 44 wherein the PCB is a PCB of a hand-held test meter for the determination of an analyte in a bodily fluid sample.

46. The method of claim 41 wherein the battery is a coin cell battery.
